(19) United States
(12) Patent Application Publication
(10) Pub. No.: US 2024/0356936 A1
(43) Pub. Date: Oct. 24, 2024

(54) CROSS-PRODUCT ALERT RISK SCORE ASSIGNER FOR EXTENDED DETECTION AND RESPONSE (XDR) SYSTEMS

(71) Applicant: Cisco Technology, Inc., San Jose, CA (US)

(72) Inventors: Jaroslav Hlavac, Praha 6 (CZ); Tomas Jirsik, Brno (CZ); Benjamin Paterek, Dudince (SK)

(21) Appl. No.: 18/368,413

(22) Filed: Sep. 14, 2023

Related U.S. Application Data
(60) Provisional application No. 63/461,384, filed on Apr. 24, 2023.

(51) Int. Cl. H04L 9/40

(52) U.S. Cl. CPC H04L 63/1416; H04L 63/1433

(57) ABSTRACT

Techniques and architecture are described for dynamically assigning a final risk score to security alerts from network devices. A first security alert from a first network device and a second security alert from a second network device are received. The first and second security alerts are generated by different security products. The first security alert and the second security alert are evaluated, using, for example, device risk scores and alert risk scores, and based at least in part on the evaluating (i) a first final risk score related to the first security alert and (ii) a second final risk score related to the second security alert are generated. The first and second final risk scores are provided to a prioritized alert queue, wherein the first security alert and the second security alert are prioritized based on values of the first final risk score and the second final risk score.

### CROSS-REFERENCE TO RELATED APPLICATION

This patent application claims priority to U.S. Provisional Patent Application No. 63/461,384, filed Apr. 24, 2023, which is fully incorporated herein by reference.

### TECHNICAL FIELD

The present disclosure relates generally to assigning cross-product alert risk scores for extended detection and response (XDR) systems, and more particularly, to dynamically assigning a correct alert risk score by combining an original alert severity (alert risk score) with information related to network asset importance (device risk score) in order to enable an alert queue to be ordered correctly while running multiple security products in various network assets.

### BACKGROUND

In current enterprise network environments, security operations center (SOC) teams are running multiple security products, often from different vendors, on various assets of a network. Each of these products generates alerts with severity scores on different scales. All alerts are forwarded to one queue ordered by the final alert severity that is tuned differently for each product, which the SOC uses to analyze the alerts and the associated assets. For example, an alert severity of 5 (severe) from one product may not be as serious as a 4 (severe) from a different product. Likewise, one product may have alert severities from 1 (not too severe) to 5 (very severe) while another product may have alert severities from 5 (not too severe) to 1 (very severe). Thus, the final queue is often not ordered correctly, as alert severity is relative and given by each product differently. Moreover, an important aspect of the real risk connected with the alert is generally missing, i.e., the role and importance of the asset in the network. As a result, the SOC team members may resolve an alert from a less important device (e.g., printer) before an alert on the critical infrastructure (e.g., production server).

Some of the products take asset importance into account. However, it is included in the alert severity and not transparent to the consumer of the alerts. Moreover, if the asset importance is available as a separate data feed, the information about the asset is not aggregated over all available security products and is not used for the prioritizing of the alert queue. Furthermore, the asset importance changes in time as the network evolves and the risk scores need to be dynamically adjusted to reflect these changes.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 schematically illustrates an example arrangement of a network that enriches security alerts with additional information to provide final risk scores, in accordance with techniques and architecture described herein.

FIG. 2 schematically illustrates an example arrangement that utilizes information to enhance security alerts from security products from various vendors, in accordance with techniques and architecture described herein.

FIG. 3 schematically illustrates an example alert risk assigner arrangement, e.g., an arrangement for the alert risk assigners of FIGS. 1 and 2, in accordance with techniques and architecture described herein.

FIG. 4 illustrates a flow diagram of an example method for dynamically assigning a correct alert risk score by combining an alert risk score with a device risk score in order to enable an alert queue to be ordered correctly while running multiple security products in various network assets, in accordance with the techniques and architecture described herein.

FIG. 5 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure provides techniques and architecture for assigning cross-product alert risk scores, especially for extended detection and response (XDR) systems. In particular, the techniques and architecture provide for dynamically assigning a correct final risk score by combining an original alert severity (also referred to as an alert risk score) with information (also referred to as device risk score) related to network asset importance, as well as other information, in order to enable an alert queue to be ordered correctly while running multiple security products in various network assets. In configurations, an alert risk assigner is a system to assign the correct final risk score to alerts coming from all the security products implemented in the network. The alert risk manager dynamically estimates the asset importance in the network and combines this information (e.g., device risk score) with the alert severity (e.g., alert risk score) into a final risk score. The alerts can then be prioritized by the final risk score, giving a security operations center (SOC) team the opportunity to resolve the most important alerts first. Thus, the techniques and architecture provide a system that dynamically computes a final risk score from alert severities originating from multiple sources, while also considering the role and the importance of the assets.

As an example, a method may include receiving, by an alert risk assigner of a network, a first security alert from a first network device, wherein the first security alert is generated by a first security product. The method may also include receiving, by the alert risk assigner, a second security alert from a second network device, wherein the second security alert is generated by a second security product. The method may further include evaluating, by the alert risk assigner, the first security alert and the second security alert. The method may also include based at least in part on the evaluating, generating, by alert risk assigner, (i) a first final risk score related to the first security alert and (ii) a second final risk score related to the second security alert. The method may further include providing, by the alert risk assigner, the first security alert with the first final risk score and the second security alert with the second final risk score to a prioritized alert queue, wherein the first security alert and the second security alert are prioritized based on values of the first final risk score and the second final risk score. The method may also include based at least in part on the prioritized alert queue, selecting, by a network security entity one of the first security alert and the second security alert for evaluation.

### EXAMPLE EMBODIMENTS

In accordance with configurations described herein, as previously noted, techniques and architecture are provided for assigning cross-product alert risk scores for extended detection and response (XDR) systems. In particular, the techniques and architecture provide for dynamically assigning a correct alert risk score by combining an original alert severity (e.g., an alert risk score) with information related to network asset importance (e.g., a device risk score) in order to enable an alert queue to be ordered correctly while running multiple security products in various network assets. In configurations, an alert risk assigner is a system to assign the correct risk score to alerts coming from all the security products implemented in the network. The alert risk assigner dynamically estimates the asset importance in the network and combines this information (e.g., the device risk score) with the alert severity (e.g., the alert risk score) into a final risk score. The security alerts can then be prioritized by the final risk score, giving a security operations center (SOC) team the opportunity to resolve the most important alerts first. Thus, the techniques and architecture provide a system that dynamically computes a final risk score from alert severities originating from multiple sources, while also considering the role and the importance of the assets.

More particularly, an alert risk assigner enriches a combined alert feed from all the individual security products for network assets or devices in a network. The alert risk assigner also communicates with static resources such as, for example, network policy. Each alert on the input to a prioritized alert queue is assigned a final risk score that is used to prioritize the alerts to a SOC team member. If the ordering is incorrect (e.g. some security product assigns severity too strictly), the SOC team member can provide feedback to the alert risk assigner to adjust weights for the specific type of alerts. Thus, the alert risk assigner may use a formula and/or machine learning (ML) model to generate the final risk scores.

In configurations, the alert risk assigner takes the alert feeds from the security products and combines the original alert severity (e.g., alert risk score) of the alert feeds with information about the asset risk and importance collected over a longer period of time (e.g., device risk score). In configurations, the final risk score may be defined in the following way by Equation 1 below:

$$FinalRiskScore = f ( AlertSeverity , DeviceRiskScore ) \qquad Equation 1$$

In Equation 1, f represents a generic function (e.g., a linear combination of AlertSeverity and DeviceRiskScore), AlertSeverity represents the original severity given by the security product in a security alert, and DeviceRiskScore represents a dynamic value aggregated from device risks provided by individual products, external resources, and the internal alert risk assigner statistics. The DeviceRiskScore changes dynamically according to the current state of the network. In configurations, the SOC team member that is consuming the alerts may provide feedback to the alert risk assigner to fine-tune the function f to provide more accurate values. A simple but powerful side-product of this approach is the propagation of information about the asset from one security product to alerts from other security products.

In configurations, the DeviceRiskScore may be estimated and updated based on two or more factors that may be combined. For example, one of the factors may include user defined information about the asset from each individual security product (if present). Another example may include network policy and other static information about the network. A further example may include dynamic asset risk estimation from the current state of the network. In configurations, not all of the factors need to be present and/or used, which enables assigning a final risk score to network devices (assets) unseen by the security products.

In configurations, the alert risk assigner may comprise extractors, a risk assigner, and an asset library.

In configurations, the asset library may store information about the asset, such as, for example, operating system (OS), known vulnerabilities, common communication hours, policy connected to the asset, etc. The input extractors may consume data feeds from individual security products and feed the normalized information to the asset library. The risk score assigner may enrich the stream of security alerts with the final risk score by combining the information in the form of device risk score from the asset library with the alert risk score.

In configurations, there are at least two ways the alert risk assigner interacts with data. As an example, a first way the alert risk assigner interacts with data may include the extractors tapping into individual product feeds and serving as adapters. The extractors may extract all the information relevant to asset risk assignment and converts the information to a normalized message, e.g., a device risk score. This normalized message may be forwarded to the asset library. Each normalized message generally contains an asset identifier. The asset library looks at the asset identifier and pulls out a record of the asset that is to be updated. If the asset is not present in the asset library, then a new record is created. In configurations, each record may have the following property types-categorical (e.g., OS type) and incremental (e.g., days active). In configurations, more property types may be included. Then, each piece of information that is not in conflict with the information in the library record is filled in. In configurations, if a conflict is detected, a message for the SOC team member is created.

As another example, a second way the alert risk assigner interacts with data, the risk assigner enriches the alert stream published to the subsequent solution, such as, for example, security information and event management system (SIEM). Each alert in the alert stream is enriched with the risk score calculated for the alert. The alert risk assigner pulls out the information about the asset from the asset library and calculates the FinalRiskScore for the alert as previously defined.

Accordingly, in configurations, a method includes receiving, by an alert risk assigner of a network, a first security alert from a first network device, wherein the first security alert is generated by a first security product. The method also includes receiving, by the alert risk assigner, a second security alert from a second network device, wherein the second security alert is generated by a second security product. The method further includes evaluating, by the alert risk assigner, the first security alert and the second security alert. The method also includes based at least in part on the evaluating, generating, by alert risk assigner, (i) a first final risk score related to the first security alert and (ii) a second final risk score related to the second security alert. The method further includes providing, by the alert risk assigner, the first security alert with the first final risk score and the second security alert with the second final risk score to a prioritized alert queue, wherein the first security alert and the second security alert are prioritized based on values of the first final risk score and the second final risk score. The method also includes based at least in part on the prioritized alert queue, selecting, by a network security entity one of the first security alert and the second security alert for evaluation.

In some configurations, the method further includes obtaining, by the alert risk assigner, first information related to the first network device, wherein the first information comprises one or more of a type of device of the first network device, an operating system (OS) of the first network device, known vulnerabilities of the first network device, common communication hours, policy connected to the first network device, an identity of a first user of the first network device, a position within the network of the first user, applications running on the first network device, an Internet Protocol (IP) address, a media access control (MAC) address, and a vendor of the first security product. In such configurations, the method also includes obtaining, by the alert risk assigner, second information related to the second network device, wherein the second information comprises one or more of a type of device of the second network device, an operating system (OS) of the second network device, known vulnerabilities of the second network device, common communication hours, policy connected to the second network device, an identity of a second user of the second network device, a position within the network of the second user, applications running on the second network device, an IP address, a MAC address and a vendor of the second security product. Also, in such configurations, evaluating, by the alert risk assigner, the first security alert and the second security alert further comprises evaluating the first information and the second information in conjunction with the first security alert and the second security alert.

In further configurations, the method comprises storing, by the alert risk assigner, the first information and the second information in a database.

In additional configurations, obtaining the first information and the second information comprises obtaining, by the alert risk assigner, the first information and the second information from the database.

In some configurations, obtaining the first information and the second information comprises obtaining, by the alert risk assigner, the first information and the second information from an external source and the method further comprises storing, by the alert risk assigner, the first information and the second information in a database.

In further configurations, the method comprises assigning, by a user of the network, at least one of (i) a first device risk to the first network device or (ii) a second device risk to the second network device. In such configurations, evaluating, by the alert risk assigner, the first security alert and the second security alert further comprises evaluating the first security alert and the second security alert in conjunction with the at least one of (i) the first device risk or (ii) the second device risk.

In additional configurations, the method further comprises receiving, by the alert risk assigner from the network security entity, feedback related to at least one of the first final risk score and the second final risk score.

Thus, the techniques and architecture provide for dynamically assigning a correct alert risk score by combining an original alert severity (e.g., alert risk score) with information related to network asset importance (e.g., a device risk score) in order to enable an alert queue to be ordered correctly while running multiple security products in various network assets. In configurations, an alert risk assigner is a system to assign the correct risk score to alerts coming from all the security products implemented in the network. The alert risk manager dynamically estimates the asset importance in the network and combines this information (e.g., the device risk score) with the alert severity (e.g., the alert risk score) into a final risk score. The alerts can then be prioritized by the final risk score, giving a security operations center (SOC) team the opportunity to resolve the most important alerts first. Thus, the techniques and architecture provide a system that dynamically computes a final risk score from alert severities originating from multiple sources, while also considering the role and the importance of the assets.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

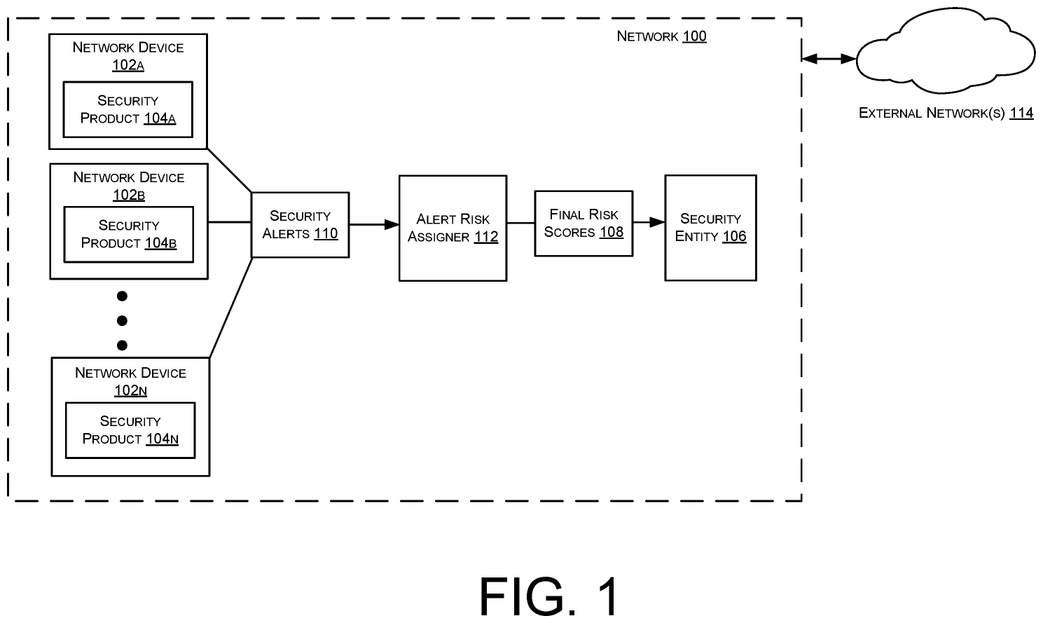

FIG. 1 schematically illustrates an example network 100 that includes network devices 102a, . . . 102n. In configurations, the network devices 102a, . . . , 102n may be a server, a computing device (e.g., a laptop, a tablet, a smart phone, a desktop computer, etc.), a peripheral device (e.g., a printer, a copy/fax machine, a router, a switch, etc.), an Internet of Things (IoT) device, etc. Each network device may include one or more security products 104a . . . 104n from various vendors. A network security entity 106 (e.g., a security operations center SOC team including one or more individual members) monitors final risk scores 108 based on security alerts 110 from the security products 104a, . . . , 104n related to the corresponding network devices 102a . . . 102n, as well as other factors as described herein. The network 100 includes an alert risk assigner 112 that provides the final risk scores 108 to the network security entity 106, as described herein. The network 100, e.g., the network devices 102a, . . . 102n may communicate with one or more other external network(s) 114, e.g., a Cloud network, a hybrid network, etc.

In configurations, the network 100 may be configured with an extended detection and response (XDR) system, although in other configurations the network is not configured with an XDR system. As is known, extended detection and response, or XDR, is an open cybersecurity architecture that integrates security tools and unifies security operations across all security layers-users, endpoints, email, applications, networks, cloud workloads and data. With XDR, security solutions that are not necessarily designed to work together, e.g., security products from different vendors, can interoperate seamlessly on threat prevention, detection, investigation and response. XDR eliminates visibility gaps between security tools and layers, enabling overburdened SOC teams to detect and resolve threats faster and more efficiently, and to capture more complete, contextual data for making better security decisions and preventing future cyber-attacks.

Today organizations are bombarded by advanced threats (also called advanced persistent threats). These threats sneak past endpoint prevention measures and lurk in the network for weeks or months—moving around, gaining permissions, stealing data, and gathering information from the different layers of the IT infrastructure in preparation for a large-scale attack or data breach. Many of the most damaging and costly cyber-attacks and data breaches—ransomware attacks, business email compromise (BEC), distributed denial of service (DDOS) attacks, cyber espionage—are examples of advanced threats.

Organizations have armed themselves with scores of cybersecurity tools and technologies to fight these threats and close off the attack vectors, or methods, that cybercriminals use to launch them. Some of these tools focus on specific infrastructure layers: others collect log data and telemetry across multiple layers. In most cases these tools are siloed, e.g., they don't talk to each other. This leaves the network security entity 106 to correlate the alerts manually to separate the actual incidents from false positives and triage the incidents according to severity and coordinate them manually to mitigate and remediate threats. As a result, advanced threats take too long to identify and contain. By breaking down the siloes between layer-specific point solutions, XDR promises overextended security teams and SOCs the end-to-end visibility and integration they need to identify threats faster, respond to them faster and resolve them faster and to minimize the damage they cause.

XDR is typically consumed as a cloud-based or software as a service (SaaS) solution. It may also be the core technology driving a cloud or security solution provider's managed detection and response (MDR) offering. For example, XDR security solutions can integrate Individual security tools (or point solutions) such as antivirus, user and entity behavior analytics (UEBA), or firewalls: layer-specific security solutions such as EDR, endpoint protection platforms (EPPs), network detection and response (NDR) or network traffic analysis (NTA); and solutions that collect data or coordinate workflows across security layers, including security information and event management (SIEM) or security orchestration, automation and response (SOAR).

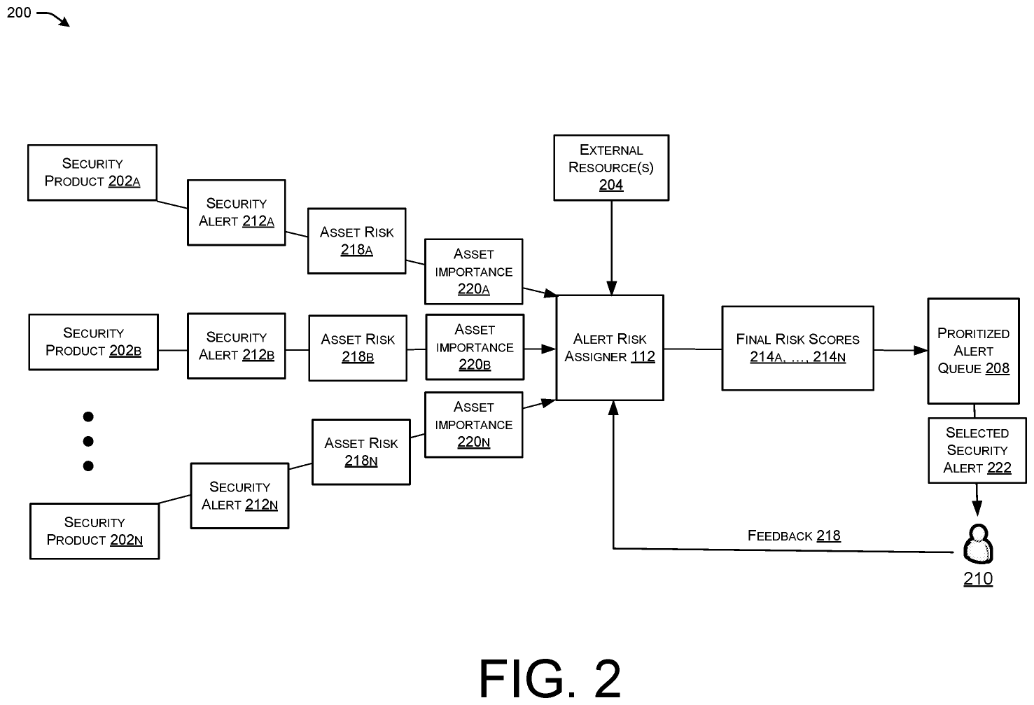

FIG. 2 schematically illustrates an example arrangement 200 that utilizes information to enhance security alerts, e.g., security alerts 110a, . . . , 110n, from security products 202a, . . . 202n (e.g., security products 104a, . . . , 104n) from various vendors. In configurations, this information is provided to an alert risk assigner 206 the generates final risk scores that are provided to a prioritized alert queue 208 that may be analyzed by a security team member 210, e.g., a member of the network security entity 106.

In configurations, the alert risk assigner 206 is a system to assign the correct risk score to security alerts 212, e.g., security alerts 110, coming from all the security products, e.g., security products 104a, . . . 104n, implemented in a network, e.g., network 100, configured with an XDR system. The alert risk assigner 206 dynamically estimates the asset importance (e.g., network device importance) in the network and combines this information in the form of a device risk score with the alert risk score into a final risk score 214. The security alerts 212 can then be prioritized based on the final risk scores 214, giving a security operations center (SOC) team, e.g., the network security entity 106, the opportunity to resolve the most important security alerts 212 first. Thus, the techniques and architecture provide a system that dynamically computes a final risk score from alert severities originating from multiple sources, while also considering the role and the importance of the assets.

In configurations, the alert risk assigner 206 enriches a combined security alert feed comprising security alerts 212a . . . , 212n from all the individual security products 202a, 202n for network assets or network devices in a network. The alert risk assigner 206 also communicates with static or external resources 204 such as, for example, network policy, network databases, etc. Each security alert 212a, . . . , 212n on the input to the prioritized alert queue 208 is assigned a corresponding final risk score 214a . . . 214n that is used to prioritize the security alerts in the prioritized alert queue for a SOC team member, e.g., security team member 210. The security alerts 212a . . . , 212n with their corresponding final risk scores 214a, . . . 214n are provided to the prioritized alert queue 208. The security team member 210 may then select a selected security alert 222 the prioritized alert queue 208 to handle based on the priority determined based on the final risk scores 214.

In configurations, if the ordering is incorrect (e.g., some security product assigns severity too strictly), the security team member 210 can provide feedback 216 to the alert risk assigner 206 to adjust weights for the specific type of security alerts 212. Thus, the alert risk assigner 206 may use a formula and/or machine learning (ML) model to generate the final risk scores 214 for the security alerts 212a, . . . , 212n.

In configurations, the alert risk assigner 206 takes the security alerts 212a, 212n from the security products 202a, . . . , 202n and combines the alert risk score of the security alerts 212a, . . . 212n (e.g., risk=1, risk=5, risk=4, etc.) with information comprising one or more of an asset risk 218a, . . . , 218n, e.g., a security risk corresponding to a network device 102 from which the security alert 212 originated, and an asset importance 220a, 220n, e.g., an importance associated with the network device 102 from which security alert 212 originated, collected over a longer period of time. The asset risks 218a . . . , 218n and the asset importances 220a, 220n may be used to define a device risk score. In configurations, the final risk score 214 may be defined in the following way by Equation 1 below:

$$FinalRiskScore = f ( AlertSeverity , DeviceRiskScore ) \qquad Equation 1$$

In Equation 1, f represents a generic function (e.g., a linear combination of AlertSeverity and DeviceRiskScore), AlertSeverity represents the original severity given by the security product 202 in a security alert 212, and DeviceRiskScore represents a dynamic value aggregated from asset risks 218a, . . . 218n provided by individual products, external resources, and the internal alert risk assigner 206 statistics. The DeviceRiskScore changes dynamically according to the current state of the network. In configurations, the security team member 210 that is consuming the final risk scores 214 may provide feedback 216 to the alert risk assigner 206 to fine-tune the function f to provide more accurate values. A simple but powerful side-product of this approach is the propagation of information about the asset (network device) from one security product 202 to security alerts 212 from other security products 202.

In configurations, the asset risks 218a, . . . , 218n may be estimated and updated based on two or more factors that may be combined. For example, one of the factors may include user defined information about the asset (network device) from each individual security product 202 (if present). Another example may include network policy and other static information about the network. Examples of the other static information may include one or more of a type of device of the network device, an operating system (OS) of the network device, known vulnerabilities of the network device, common communication hours, policy connected to the network device, an identity of a user of the first network device, a position within the network of the user, applications running on the network device, an Internet Protocol (IP) address, a media access control (MAC) address, and a vendor of the security product associated with the network device. A further example may include dynamic asset risk estimation from the current state of the network. In configurations, not all of the factors need to be present and/or used, which enables assigning a final risk score 214 to assets (network devices) unseen by the security products 202.

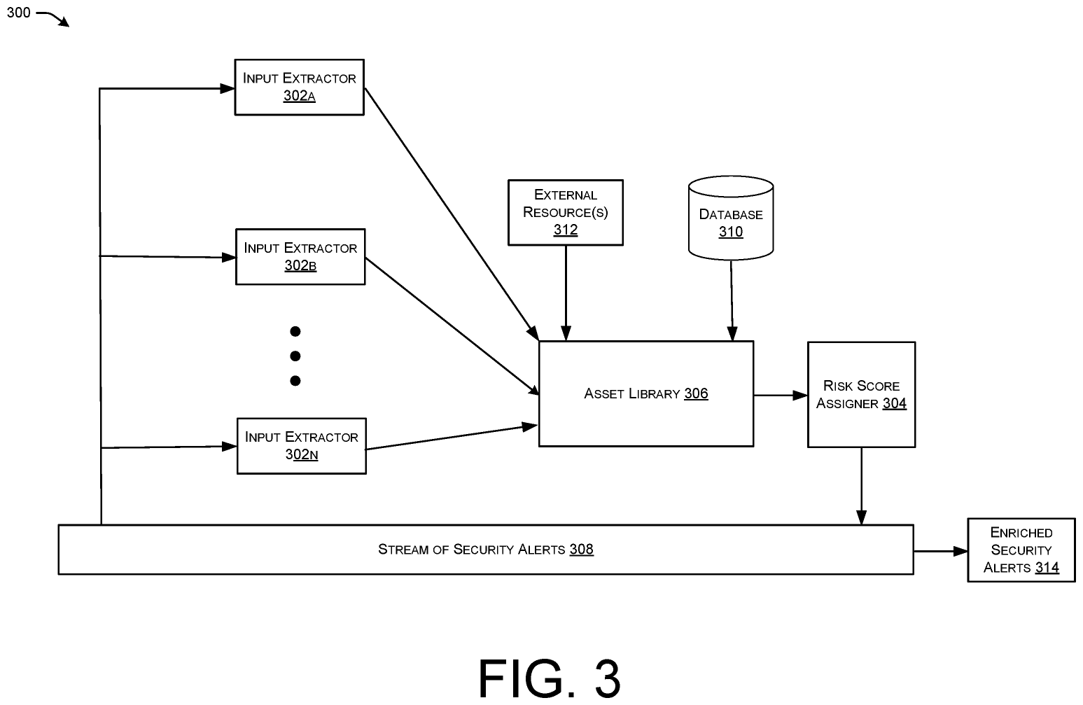

FIG. 3 schematically illustrates an example alert risk assigner arrangement 300, e.g., an arrangement for alert risk assigner 206. In configurations, the alert risk assigner arrangement 300 may comprise one or more input extractors 302a . . . , 302n, a risk score assigner 304, e.g., alert risk assigner 206, and an asset library 306.

In configurations, the asset library 306 may store information about the asset (network device), such as, for example, operating system (OS), known vulnerabilities, common communication hours, policy connected to the asset, etc. The input extractors 302 may consume data feeds from individual security products, e.g., security products 202, and feed the information, which may be normalized, to the asset library 306. The risk score assigner 304 may enrich a stream 308 of security alerts, e.g., security alerts 212, from the security products with the final risk scores, e.g., the final risk scores 214, by combining the information from the asset library 306 with the alert risk score of the security alerts. This provides enriched security alerts 314, e.g., final risk scores 214.

In configurations, there are at least two ways the alert risk assigner 304 may interact with data. As an example, a first way the alert risk assigner 304 interacts with data may include the input extractors 302 tapping into individual security product feeds and serving as adapters. The input extractors 302 may extract all the information relevant to asset risk assignment and convert the information to a normalized message, e.g., a device risk score. This normalized message may be forwarded to the asset library 306. Each normalized message generally contains an asset identifier. The asset library 306 looks at the asset identifier and pulls out a record of the asset (network device) that is to be updated. If the asset is not present in the asset library 306, then a new record is created. In configurations, each record may have the following property types-categorical (e.g., OS type) and incremental (e.g., days active). In configurations, more property types may be included. For example, other property types may include one or more of a type of device of the network device, an operating system (OS) of the network device, known vulnerabilities of the network device, common communication hours, policy connected to the network device, an identity of a user of the first network device, a position within the network of the user, and a vendor of the security product associated with the network device. Then, each piece of information that is not in conflict with the information in the library record is filled in. In configurations, if a conflict is detected, a message for a security team member, e.g., security team member 210, is created for the security team member to resolve. In configurations, the conflict resolution may be subject to the severity of the conflict and/or a time difference between updates of the information in library record.

The records may be stored in a database 310. Additionally, external resources 312, external resources 204, may be searched if needed to obtain information described herein for the records and stored in the database 310. When calculating the final risk scores, the database 310 may be searched for the information. If the information is not present, e.g., the asset is not present in the asset library 306, external resources, e.g., static or external resources 204.

As another example, a second way the alert risk assigner 304 may interact with data, the alert risk assigner 304 enriches the alert stream published to a subsequent solution, such as, for example, a security information and event management system (SIEM). Each security alert in the alert stream is enriched with the risk score calculated for the security alert. The alert risk assigner 304 pulls out the information about the asset from the asset library 306 and calculates the FinalRiskScore for the security alert as previously described.

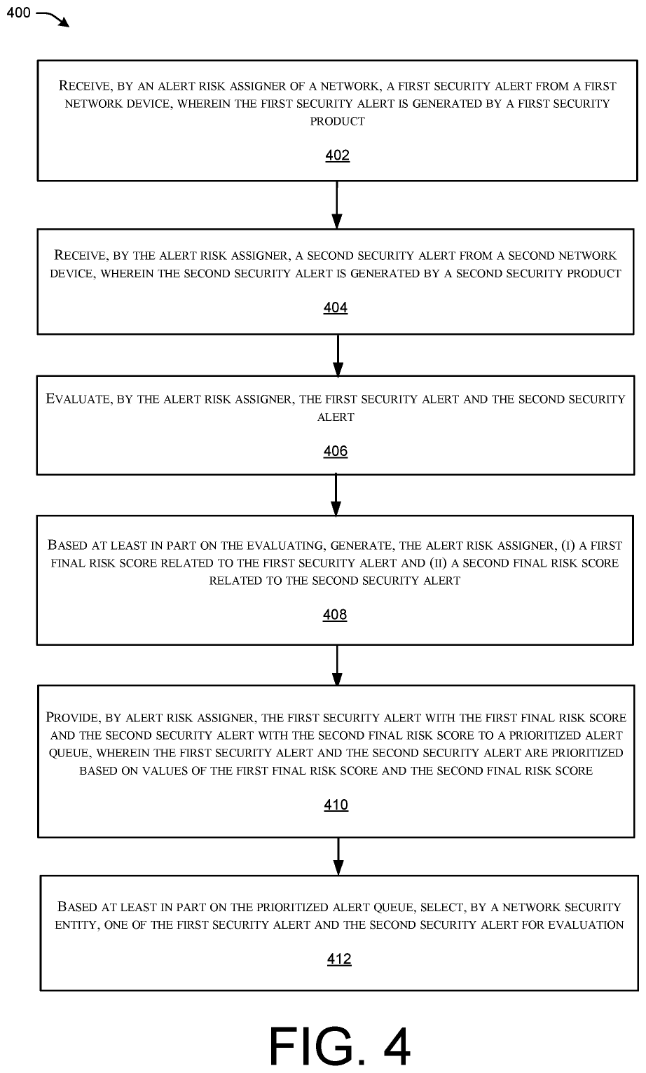

FIG. 4 illustrates a flow diagram of an example method 400 and illustrates aspects of the functions performed at least partly by devices of a network as described with respect to FIGS. 1-3. The logical operations described herein with respect to FIG. 4 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 4 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 4 illustrates a flow diagram of an example method 400 for dynamically assigning a correct alert risk score by combining an alert risk score with a device risk score related to network asset importance in order to enable an alert queue to be ordered correctly while running multiple security products in various network assets. In some examples, the method 400 may be performed by a system comprising one or more processors and one or more non-transitory computer-readable media storing computer-executable instructions that, when executed by the one or more processors, cause the one or more processors to perform the method 400.

At 402, an alert risk assigner of a network receives a first security alert from a first network device, wherein the first security alert is generated by a first security product. For example, the alert risk assigner 206 receives security alerts 212a, . . . , 212n from security products 202a, . . . , 202n (e.g., security products 104a, . . . , 104n), associated with network devices associated with network devices, e.g., network devices 102a, . . . , 102n.

At 404, the alert risk assigner receives a second security alert from a second network device, wherein the second security alert is generated by a second security product. For example, the alert risk assigner 206 receives security alerts 212a, . . . , 212n from security products 202a, . . . , 202n (e.g., security products 104a, . . . , 104n) associated with network devices, e.g., network devices 102a, . . . , 102n.

At 406, the alert risk assigner evaluates the first security alert and the second security alert. For example, in configurations, the alert risk assigner 206 enriches a combined security alert feed comprising security alerts 212a, . . . , 212n from all the individual security products 202a, . . . , 202n for network assets or network devices in a network. The alert risk assigner 206 also communicates with static or external resources 204 such as, for example, network policy, network databases, etc. Each security alert 212 on the input to the prioritized alert queue 208 is assigned a corresponding final risk score 214a, . . . , 214n that is used to prioritize the security alerts to a SOC team member, e.g., security team member 210. If the ordering is incorrect (e.g., some security product assigns severity too strictly), the security team member 210 can provide feedback 216 to the alert risk assigner 206 to adjust weights for the specific type of security alerts 212. Thus, the alert risk assigner 206 may use a formula and/or machine learning (ML) model to generate the final risk scores 214.

At 408, based at least in part on the evaluating, the alert risk assigner generates (i) a first final risk score related to the first security alert and (ii) a second final risk score related to the second security alert. For example, In configurations, the alert risk assigner 206 takes the security alerts 212a . . . , 212n from the security products 202a, . . . 202n and combines the alert risk scores of the security alerts 212a . . . , 212n with information comprising one or more of an asset risk 218a, . . . , 218n, e.g., a security risk corresponding to a network device 102 from which the security alert 212 originated, and an asset importance 220, e.g., an importance associated with the network device 102 from which security alert 212 originated, collected over a longer period of time. The asset risks 218a, . . . , 218n and the asset importances 220a, 220n may be used to define a device risk score. In configurations, the final risk score 214 may be defined in the following way by Equation 1 below:

$$FinalRiskScore = f ( AlertSeverity , DeviceRiskScore ) \qquad Equation 1$$

In Equation 1, f represents a generic function (e.g., a linear combination of AlertSeverity and DeviceRiskScore), AlertSeverity represents the original severity given by the security product 202 in a security alert 212, and DeviceRiskScore represents a dynamic value aggregated from asset risks 218a, . . . , 218n provided by individual products, external resources, and the internal alert risk assigner 206 statistics. The DeviceRiskScore changes dynamically according to the current state of the network. In configurations, the security team member 210 that is consuming the final risk scores 214 may provide feedback 216 to the alert risk assigner 206 to fine-tune the function f to provide more accurate values. A simple but powerful side-product of this approach is the propagation of information about the asset (network device) from one security product 202 to security alerts 212 from other security products 202.

In configurations, the asset risk 218a, . . . , 218n may be estimated and updated based on two or more factors that may be combined. For example, one of the factors may include user defined information about the asset (network device) from each individual security product 202 (if present). Another example may include network policy and other static information about the network. Examples of the other static information may include one or more of a type of device of the network device, an operating system (OS) of the network device, known vulnerabilities of the network device, common communication hours, policy connected to the network device, an identity of a user of the first network device, a position within the network of the user, applications running on the network device, an Internet Protocol (IP) address, a media access control (MAC) address, and a vendor of the security product associated with the network device. A further example may include dynamic asset risk estimation from the current state of the network. In configurations, not all of the factors need to be present and/or used, which enables assigning a final risk score 214 to assets (network devices) unseen by the security products 202.

At 410, the alert risk assigner provides the first security alert with the first final risk score and the second security alert with the second final risk score to a prioritized alert queue, wherein the first security alert and the second security alert are prioritized based on values of the first final risk score and the second final risk score. For example, the security alerts 212a, . . . , 212n with their corresponding final risk scores 214a . . . , 214n are provided to the prioritized alert queue 208.

At 412, based at least in part on the prioritized alert queue, a network security entity selects one of the first security alert and the second security alert for evaluation. For example, the security team member 210 may select a security alert 212 to handle based on the priority.

Thus, in accordance with configurations described herein, a correct alert risk score may be dynamically assigned by combining an alert risk score with a device risk score related to network asset importance in order to enable an alert queue to be ordered correctly while running multiple security products in various network assets. In configurations, an alert risk assigner is a system to assign the correct risk score to alerts coming from all the security products implemented in the network. The alert risk manager dynamically estimates the asset importance in the network and combines this device risk score with the alert risk score into a final risk score. The alerts can then be prioritized by the final risk score, giving a security operations center (SOC) team the opportunity to resolve the most important alerts first. Thus, the techniques and architecture provide a system that dynamically computes a final risk score from alert severities originating from multiple sources, while also considering the role and the importance of the assets.

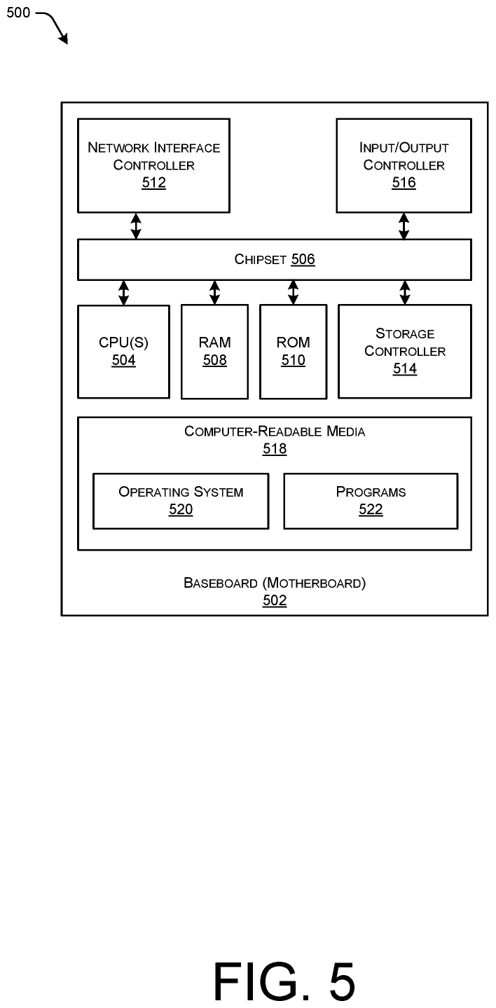

FIG. 5 shows an example computer architecture for a computing device 500 capable of executing program components for implementing the functionality described above. In configurations, one or more of the computing devices 500 may be used to implement one or more of the components of FIGS. 1-4. The computer architecture shown in FIG. 5 illustrates a conventional server computer, router, switch, workstation, desktop computer, laptop, tablet, network appliance, e-reader, smartphone, or other computing device, and can be utilized to execute any of the software components presented herein. The computing device 500 may, in some examples, correspond to a physical device or resources described herein.

The computing device 500 includes a baseboard 502, or “motherboard.” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computing device 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computing device 500. The chipset 506 can further provide an interface to a computer-readable storage medium such as a read-only memory (“ROM”) 510 or non-volatile RAM (“NVRAM”) for storing basic routines that help to startup the computing device 500 and to transfer information between the various components and devices. The ROM 510 or NVRAM can also store other software components necessary for the operation of the computing device 500 in accordance with the configurations described herein.

The computing device 500 can operate in a networked environment using logical connections to remote computing devices and computer systems through a network. The chipset 506 can include functionality for providing network connectivity through a NIC 512, such as a gigabit Ethernet adapter. In configurations, the NIC 512 can be a smart NIC (based on data processing units (DPUs)) that can be plugged into data center servers to provide networking capability. The NIC 512 is capable of connecting the computing device 500 to other computing devices over networks. It should be appreciated that multiple NICs 512 can be present in the computing device 500, connecting the computer to other types of networks and remote computer systems.

The computing device 500 can include a storage device 518 that provides non-volatile storage for the computer. The storage device 518 can store an operating system 520, programs 522, and data, which have been described in greater detail herein. The storage device 518 can be connected to the computing device 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computing device 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 can further read information from the storage device 518 by detecting the physical states or characteristics of one or more particular locations within the physical storage units.

In addition to the mass storage device 518 described above, the computing device 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 500. In some examples, the operations performed by the cloud network, and or any components included therein, may be supported by one or more devices similar to computing device 500. Stated otherwise, some or all of the operations described herein may be performed by one or more computing devices 500 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computing device 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 518 can store other system or application programs and data utilized by the computing device 500.

In one embodiment, the storage device 518 or other computer-readable storage media is encoded with computer-executable instructions which, when loaded into the computing device 500, transform the computer from a general-purpose computing system into a special-purpose computer capable of implementing the embodiments described herein. These computer-executable instructions transform the computing device 500 by specifying how the CPUs 504 transition between states, as described above. According to one embodiment, the computing device 500 has access to computer-readable storage media storing computer-executable instructions which, when executed by the computing device 500, perform the various processes described above with regard to FIGS. 1-4. The computing device 500 can also include computer-readable storage media having instructions stored thereupon for performing any of the other computer-implemented operations described herein.

The computing device 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computing device 500 might not include all of the components shown in FIG. 5, can include other components that are not explicitly shown in FIG. 5, or might utilize an architecture completely different than that shown in FIG. 5.

The computing device 500 may support a virtualization layer, such as one or more virtual resources executing on the computing device 500. In some examples, the virtualization layer may be supported by a hypervisor that provides one or more virtual machines running on the computing device 500 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, by an alert risk assigner of a network, a first security alert from a first network device, wherein the first security alert is generated by a first security product:
receiving, by the alert risk assigner, a second security alert from a second network device, wherein the second security alert is generated by a second security product:
evaluating, by the alert risk assigner, the first security alert and the second security alert:
based at least in part on the evaluating, generating, by alert risk assigner, (i) a first final risk score related to the first security alert and (ii) a second final risk score related to the second security alert:
providing, by the alert risk assigner, the first security alert with the first final risk score and the second security alert with the second final risk score to a prioritized alert queue, wherein the first security alert and the second security alert are prioritized based on values of the first final risk score and the second final risk score; and
based at least in part on the prioritized alert queue, selecting, by a network security entity one of the first security alert and the second security alert for evaluation.

2. The method of claim 1, further comprising:
obtaining, by the alert risk assigner, first information related to the first network device, wherein the first information comprises one or more of a type of device of the first network device, an operating system (OS) of the first network device, known vulnerabilities of the first network device, common communication hours, policy connected to the first network device, an identity of a first user of the first network device, a position within the network of the first user, applications running on the first network device, an Internet Protocol (IP) address, a media access control (MAC) address, and a vendor of the first security product; and
obtaining, by the alert risk assigner, second information related to the second network device, wherein the second information comprises one or more of a type of device of the second network device, an operating system (OS) of the second network device, known vulnerabilities of the second network device, common communication hours, policy connected to the second network device, an identity of a second user of the second network device, a position within address, a MAC address, and a vendor of the second security product,
wherein evaluating, by the alert risk assigner, the first security alert and the second security alert further comprises evaluating the first information and the second information in conjunction with the first security alert and the second security alert.

3. The method of claim 2, further comprising:
storing, by the alert risk assigner, the first information and the second information in a database.

4. The method of claim 3, wherein obtaining the first information and the second information comprises obtaining, by the alert risk assigner, the first information and the second information from the database.

5. The method of claim 2, wherein:
obtaining the first information and the second information comprises obtaining, by the alert risk assigner, the first information and the second information from an external source; and
the method further comprises storing, by the alert risk assigner, the first information and the second information in a database.

6. The method of claim 1, further comprising:
assigning, by a user of the network, at least one of (i) a first device risk to the first network device or (ii) a second device risk to the second network device,
wherein evaluating, by the alert risk assigner, the first security alert and the second security alert further comprises evaluating the first security alert and the second security alert in conjunction with the at least one of (i) the first device risk or (ii) the second device risk.

7. The method of claim 1, further comprising:
receiving, by the alert risk assigner from the network security entity, feedback related to at least one of the first final risk score and the second final risk score.

8. A system comprising:
one or more processors; and
one or more non-transitory computer-readable media storing computer-executable instructions that, when executed by the one or more processors, cause the one or more processors to perform actions comprising:
receiving, by an alert risk assigner of a network, a first security alert from a first network device, wherein the first security alert is generated by a first security product:
receiving, by the alert risk assigner, a second security alert from a second network device, wherein the second security alert is generated by a second security product:
evaluating, by the alert risk assigner, the first security alert and the second security alert:
based at least in part on the evaluating, generating, by alert risk assigner, (i) a first final risk score related to the first security alert and (ii) a second final risk score related to the second security alert:
providing, by the alert risk assigner, the first security alert with the first final risk score and the second security alert with the second final risk score to a prioritized alert queue, wherein the first security alert and the second security alert are prioritized based on values of the first final risk score and the second final risk score; and
based at least in part on the prioritized alert queue, selecting, by a network security entity one of the first security alert and the second security alert for evaluation.

9. The system of claim 8, wherein the actions further comprise:
obtaining, by the alert risk assigner, first information related to the first network device, wherein the first information comprises one or more of a type of device of the first network device, an operating system (OS) of the first network device, known vulnerabilities of the first network device, common communication hours, policy connected to the first network device, an identity of a first user of the first network device, a position within the network of the first user, applications running on the first network device, an Internet Protocol (IP) address, a media access control (MAC) address, and a vendor of the first security product; and
obtaining, by the alert risk assigner, second information related to the second network device, wherein the second information comprises one or more of a type of device of the second network device, an operating system (OS) of the second network device, known vulnerabilities of the second network device, common communication hours, policy connected to the second network device, an identity of a second user of the second network device, a position within address, a MAC address, and a vendor of the second security product,
wherein evaluating, by the alert risk assigner, the first security alert and the second security alert further comprises evaluating the first information and the second information in conjunction with the first security alert and the second security alert.

10. The system of claim 9, wherein the actions further comprise:
storing, by the alert risk assigner, the first information and the second information in a database.

11. The system of claim 10, wherein obtaining the first information and the second information comprises obtaining, by the alert risk assigner, the first information and the second information from the database.

12. The system of claim 9, wherein:
obtaining the first information and the second information comprises obtaining, by the alert risk assigner, the first information and the second information from an external source; and
the actions further comprise storing, by the alert risk assigner, the first information and the second information in a database.

13. The system of claim 8, wherein the actions further comprise:
assigning, by a user of the network, at least one of (i) a first device risk to the first network device or (ii) a second device risk to the second network device,
wherein evaluating, by the alert risk assigner, the first security alert and the second security alert further comprises evaluating the first security alert and the second security alert in conjunction with the at least one of (i) the first device risk or (ii) the second device risk.

14. The system of claim 8, wherein the actions further comprise:
receiving, by the alert risk assigner from the network security entity, feedback related to at least one of the first final risk score and the second final risk score.

15. One or more non-transitory computer-readable media storing computer-executable instructions that, when executed by one or more processors, cause the one or more processors to perform actions comprising:
receiving, by an alert risk assigner of a network, a first security alert from a first network device, wherein the first security alert is generated by a first security product:
receiving, by the alert risk assigner, a second security alert from a second network device, wherein the second security alert is generated by a second security product:
evaluating, by the alert risk assigner, the first security alert and the second security alert:
based at least in part on the evaluating, generating, by alert risk assigner, (i) a first final risk score related to the first security alert and (ii) a second final risk score related to the second security alert:
providing, by the alert risk assigner, the first security alert with the first final risk score and the second security alert with the second final risk score to a prioritized alert queue, wherein the first security alert and the second security alert are prioritized based on values of the first final risk score and the second final risk score; and
based at least in part on the prioritized alert queue, selecting, by a network security entity one of the first security alert and the second security alert for evaluation.

16. The one or more non-transitory computer-readable media of claim 15, wherein the actions further comprise:
obtaining, by the alert risk assigner, first information related to the first network device, wherein the first information comprises one or more of a type of device of the first network device, an operating system (OS) of the first network device, known vulnerabilities of the first network device, common communication hours, policy connected to the first network device, an identity of a first user of the first network device, a position within the network of the first user, applications running on the first network device, an Internet Protocol (IP) address, a media access control (MAC) address, and a vendor of the first security product; and
obtaining, by the alert risk assigner, second information related to the second network device, wherein the second information comprises one or more of a type of device of the second network device, an operating system (OS) of the second network device, known vulnerabilities of the second network device, common communication hours, policy connected to the second network device, an identity of a second user of the second network device, a position within address, a MAC address, and a vendor of the second security product,
wherein evaluating, by the alert risk assigner, the first security alert and the second security alert further comprises evaluating the first information and the second information in conjunction with the first security alert and the second security alert.

17. The one or more non-transitory computer-readable media of claim 16, wherein the actions further comprise:
storing, by the alert risk assigner, the first information and the second information in a database.

18. The one or more non-transitory computer-readable media of claim 17, wherein obtaining the first information and the second information comprises obtaining, by the alert risk assigner, the first information and the second information from the database.

19. The one or more non-transitory computer-readable media of claim 16, wherein:
obtaining the first information and the second information comprises obtaining, by the alert risk assigner, the first information and the second information from an external source; and
the actions further comprise storing, by the alert risk assigner, the first information and the second information in a database.

20. The one or more non-transitory computer-readable media of claim 15, wherein the actions further comprise:
assigning, by a user of the network, at least one of (i) a first device risk to the first network device or (ii) a second device risk to the second network device,
wherein evaluating, by the alert risk assigner, the first security alert and the second security alert further comprises evaluating the first security alert and the second security alert in conjunction with the at least one of (i) the first device risk or (ii) the second device risk.
